(19) United States
(12) Patent Application Publication
(10) Pub. No.: US 2026/0121842 A1
(43) Pub. Date: Apr. 30, 2026

(54) MULTI-ENTANGLED PHOTON SOURCE-BASED MULTI-LEVEL USER QUANTUM KEY DISTRIBUTION NETWORK AND DISTRIBUTION METHOD

(71) Applicant: Hangzhou Normal University, Hangzhou (CN)

(72) Inventors: Lijiong SHEN, Hangzhou (CN); Zehua TIAN, Hangzhou (CN); Yihao KANG, Hangzhou (CN); Yu WANG, Hangzhou (CN); Qiping SU, Hangzhou (CN); Zhe SUN, Hangzhou (CN)

(73) Assignee: Hangzhou Normal University, Hangzhou (CN)

(21) Appl. No.: 19/387,715

(22) Filed: Nov. 13, 2025

Related U.S. Application Data
(63) Continuation of application No. PCT/CN2025/129164, filed on Oct. 22, 2025.

(30) Foreign Application Priority Data
Oct. 24, 2024 (CN) 202411488606.4

(51) Int. Cl. H04L 9/08

(52) U.S. Cl. CPC H04L 9/0852

(57) ABSTRACT

Disclosed is a multi-entangled photon source-based multi-level user quantum key distribution network and distribution method. Bandwidth requirements can be effectively dispersed by introducing a plurality of entangled photon sources, enabling a quantum entanglement-based quantum secure communication network supporting a plurality of users to be possible. When arranging the second-level photon source, problems of transmission loss and quantum key rate decline caused by an excessively long distance between users in a same user group and a central entangled photon source can be effectively alleviated. Under a multi-user hierarchical framework, the pressure of the central photon source has been further reduced, which provides the possibility for building an entanglement-based secure communication network with more users and a wider range.

### CROSS-REFERENCE TO RELATED APPLICATIONS

The application claims priority to Chinese patent application No. 202411488606.4, filed on Oct. 24, 2024, the entire contents of which are incorporated herein by reference.

### TECHNICAL FIELD

This disclosure relates to the technical field of quantum communication, and in particular to a multi-entangled photon source-based multi-level user quantum key distribution network and distribution method.

### BACKGROUND

As a technology that utilizes the quantum no-cloning theorem to ensure the absolute security of communication, quantum key distribution (QKD) has been widely studied and developed since the first BB84 protocol was proposed in 1984. However, although the BB84 protocol is theoretically absolutely secure, it needs an ideal single photon source for its implementation, which is still a challenge in experiment. Therefore, subsequent protocols such as E91 and BBM92 emerged, which use entangled photon sources as information carriers, thus physically overcoming security problems caused by imperfect photon sources.

The existing quantum entanglement-based quantum key distribution technology usually uses two-photon entanglement sources, to distribute two photons in an entangled photon pair to two users respectively for quantum key distribution. However, this solution can only meet the demand of point-to-point secure communication. In order to expand a communication range, researchers try to use high-dimensional or many-body quantum entanglement, but this method consumes a lot of resources and the technology is not yet mature.

In order to build a multi-user quantum communication network, a common method is to use trusted quantum nodes to expand the network. However, this method reduces the security of quantum key distribution. Once any relay node is breached, the security of the whole network will be threatened. Another method is to achieve distribution by using entangled photon pairs generated by a single central entangled photon source through wavelength division multiplexing technology. Although this method can achieve multi-user fully connected entangled distribution and quantum key distribution, its limitation is that a bandwidth of the single entangled photon source is limited, which is difficult to generate enough entangled photon pair channels to meet secure communication requirements of large-scale users.

### SUMMARY

Embodiments of this disclosure provide a multi-entangled photon source-based multi-level user quantum key distribution network and distribution method, which improves the security, expansibility, efficiency, and optical fiber resource utilization rate of a quantum secure communication network.

To achieve the foregoing objectives, the technical solutions of the embodiments of this disclosure are as follows:

According to a first aspect, an embodiment of this disclosure provides a multi-entangled photon source-based multi-level user quantum key distribution network system, including: a multi-level entangled photon source structure for generating entangled photon pairs, where the multi-level entangled photon source structure includes a first-level multi-channel entangled photon source and at least one second-level multi-channel entangled photon source; and
a plurality of user groups for receiving the entangled photon pairs, where users in each user group are divided into a first-level user and a second-level user through a preset user classification manner; where each user group includes at least one first-level user.

Quantum key distribution is performed between the first-level users through the first-level multi-channel entangled photon source, so as to realize fully connected and secure communication between the first-level users; and
in each user group, quantum key distribution is performed between the second-level users and the first-level users in the group through the second-level entangled photon source, so as to realize fully connected and secure communication in each corresponding user group.

In some possible implementations, the first-level multi-channel entangled photon source and the second-level multi-channel entangled photon source both perform entangled photon pair distribution through a wavelength division multiplexing technology.

In some possible implementations, the first-level multi-channel entangled photon source is arranged at a network center or a central position of the user groups, so as to provide an efficient quantum key distribution service for the first-level users.

In some possible implementations, the second-level multi-channel entangled photon source is arranged inside a corresponding user group, so as to provide a quantum key distribution service in the corresponding user group.

In some possible implementations, when deploying the second-level multi-channel entangled photon source, a wavelength band that is not commonly used in telecommunication optical communication and has a slightly higher loss per transmission distance is adopted for arrangement.

In some possible implementations, the user groups are divided based on geographical locations.

According to a second aspect, an embodiment of this disclosure provides a multi-entangled photon source-based multi-level user quantum key distribution method, applied to a multi-entangled photon source-based multi-level user quantum key distribution network system according to the first aspect. The method includes: dividing users into different user groups according to their geographical locations;
dividing users in each user group into a first-level user and a second-level user through a preset user classification manner, where each user group includes at least one first-level user;
deploying a first-level multi-channel entangled photon source at the center of the user groups, and performing quantum key distribution between the first-level users through the first-level multi-channel entangled photon source, so as to realize fully connected and secure communication between the first-level users; and
in the user group, performing quantum key distribution between the second-level users and the first-level users in the group through the second-level multi-channel entangled photon source, so as to realize fully connected and secure communication in each corresponding user group.

One or more technical solutions provided in the embodiments of this disclosure have at least the following technical effects or advantages:

In the embodiments of this disclosure, bandwidth requirements can be effectively dispersed by introducing a plurality of entangled photon sources, enabling a quantum entanglement-based quantum secure communication network supporting a plurality of users (for example, more than 10) to be possible. When arranging the second-level photon source, problems of transmission loss and quantum key rate decline caused by an excessively long distance between users in a same user group and a central entangled photon source can be effectively alleviated. Under a framework of multi-user hierarchy, the pressure of the central photon source has been further reduced, which provides the possibility for building an entanglement-based secure communication network with more users and a wider range.

### BRIEF DESCRIPTION OF THE DRAWINGS

To describe the embodiments of this disclosure more clearly, the following briefly introduces the accompanying drawings required for describing the embodiments. Apparently, the accompanying drawings in the following description show some embodiments of this disclosure, and those of ordinary skill in the art may still derive other accompanying drawings from these accompanying drawings without creative efforts.

FIG. 1 is a schematic diagram of a central entangled photon source and network distribution of a quantum communication network which realizes multi-user full connectivity by using entangled photon sources and wavelength division multiplexing;

FIG. 2 is a schematic diagram of a quantum communication network based on entanglement and wavelength division multiplexing for users;

FIG. 3 is a schematic diagram of quantum key distribution of a single entangled photon source in the prior art;

FIG. 4 is a schematic diagram of a multi-entangled photon source-based quantum key distribution network;

FIG. 5 is a structural schematic diagram of a multi-entangled photon source-based multi-level user quantum key distribution network system provided by an embodiment of this disclosure; and

FIG. 6 is a schematic flowchart of a multi-entangled photon source-based multi-level user quantum key distribution method provided by an embodiment of this disclosure.

### DETAILED DESCRIPTION OF THE EMBODIMENTS

The following describes the technical solutions in embodiments of this disclosure clearly and completely with reference to the accompanying drawings in the embodiments of this disclosure. Obviously, the described embodiments are some, but not all, of the embodiments of this disclosure. All other embodiments obtained by a person of ordinary skill in the art based on the embodiments of this disclosure without creative efforts shall fall within the protection scope of this disclosure.

In related description of the embodiments, the terms “include”, “contain”, “have”, or the like are open-class terms, which are generally understood as including but not limited to; the term “at least one” is generally understood as one or more, and “a plurality of” refers to two or more; the term “at least one of the following” or similar expressions refer to any combination of these items, including any combination of single or plural items, for example, “at least one of a, b, or c” or “at least one of a, b, and c” may each represent a, b, c, a-b (i.e., a and b), a-c, b-c, or a-b-c, where a, b, and c may each be a single or multiple; and the symbol “A/B” is used to describe a selection relationship of associated objects, and generally refers to an “or” relationship between the associated objects.

In the following description of the embodiments, the terms used in the embodiments of this disclosure are merely for a purpose of describing a specific embodiment, and are not intended to limit this disclosure. The terms “a” and “the” of singular forms used in the embodiments and the appended claims of this disclosure are also intended to include plural forms, unless otherwise specified in a context clearly.

A person of ordinary skill in the art should understand that serial number sequences in the following description of the embodiments do not mean execution sequences in various embodiments of this disclosure. Some or all steps can be executed in parallel or in sequence. The execution sequences of the processes should be determined according to functions and internal logic of the processes, and should not be construed as any limitation on the implementation processes of the embodiments of this disclosure.

A person of ordinary skill in the art should understand that a numerical range in the embodiments of this disclosure should be understood as specifically disclosing each intermediate value between an upper limit and a lower limit of the range. The intermediate value within any stated value or stated range and every smaller range between the intermediate value within any other stated value or the range are also included in this disclosure. The upper and lower limits of these smaller ranges can be independently included in or excluded from the range.

Unless otherwise stated, all technical/scientific terms used herein have the same meanings as those commonly understood by those of ordinary skill in the art to which this disclosure belongs. Although this disclosure only describes the preferred methods and materials, any methods and materials similar to or equivalent to those herein can also be used in the implementation or testing of this disclosure. All literatures mentioned in this specification are incorporated by reference to disclose and describe methods and/or materials related to the literatures. In case of conflict with any incorporated literature, it is subject to the contents of this specification.

In order to describe the technical solutions of this disclosure, specific embodiments are used for description.

Quantum key distribution ensures the absolute security of communication by using a quantum no-cloning theorem. In 1984, the first quantum key distribution protocol, BB84 protocol, was proposed. Although this protocol is theoretically absolutely secure, it needs an ideal single photon source, but such a single photon source cannot be experimentally prepared completely. The use of a non-ideal single photon source will cause certain security loopholes. Subsequently, E91 and BBM92 protocols were proposed respectively in 1991 and 1992, which use entangled photon sources as information carriers, thus physically overcoming security problems caused by imperfect photon sources. Two-photon entanglement sources are usually used in the prior art, to distribute two photons in an entangled photon pair to two users respectively for quantum key distribution. However, such quantum key distribution can only meet point-to-point secure communication.

In order to realize multi-person (quantum network) communication, there are usually the following existing methods:
1. A quantum repeater-type quantum network using quantum memory and entanglement swapping is used, but the quantum memory has very low efficiency at present and has not yet reached a practical stage.
2. High-dimensional or many-body quantum entanglement is used, but this method consumes a lot of resources and the technology is not yet mature.
3. Trusted quantum nodes are used to extend the quantum network, which is the most commonly used quantum secure network implementation method at present. However, the trusted quantum nodes reduce the security of quantum key distribution.
4. One-to-many quantum communication is used, but the use of a passive beam splitter may greatly reduce a secure key rate. The use of an active optical switch can improve the flexibility, but it also reduces the security, only users between optical switch groups can communicate with each other, and group users cannot perform direct communication.
5. Entangled photon sources and wavelength division multiplexing are used to realize a multi-user fully connected quantum communication network, which is also the most flexible and robust structure at present. This structure can effectively realize fully connected entanglement distribution and quantum key distribution between a plurality of users.

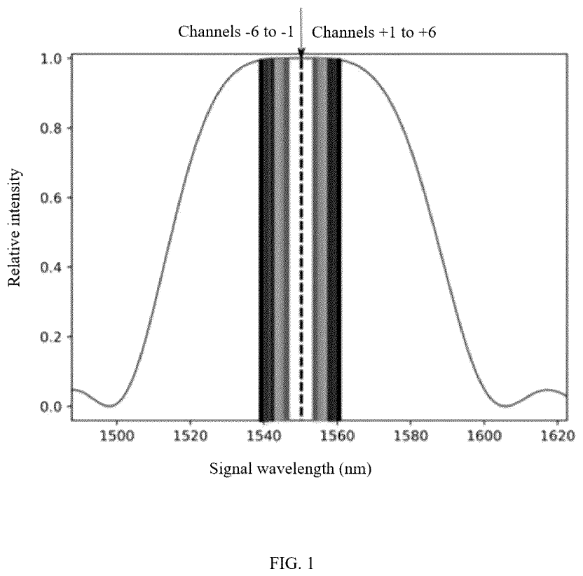

For example, FIG. 1 is a schematic diagram of a central entangled photon source and network distribution of a quantum communication network which realizes multi-user full connectivity by using entangled photon sources and wavelength division multiplexing.

As shown in FIG. 1, the schematic diagram of an entangled photon source centered at 1550 nm shows a system designed based on a principle of conservation of energy. The system uses a 775 nm pump light to excite and generate entangled photon pairs. Due to the conservation of energy, the total energy of the two entangled photons needs to be equal to the energy of a 775 nm photon. Therefore, the energy of the two entangled photons may be symmetrically distributed on both sides of 1550 nm. (The energy of the 1550 nm photon is equal to half that of the 775 nm photon, and the energy of a photon is inversely proportional to its wavelength and directly proportional to its frequency), and this characteristic can be applied to a channel wavelength specified by the International Telecommunication Union (ITU) Standardization Sector. In FIG. 1, centered at 1550 nm, wavelengths on both sides are divided into 12 channels according to ITU standards, in which a left side (a side with shorter wavelengths) of 1550 nm is labeled as −6 to −1 from left to right, while a right side (a side with longer wavelengths) is labeled as +1 to +6 from left to right. According to the principle of conservation of energy, photons in the +1 channel and −1 channel form one entangled photon pair, and so on until +6 and −6, totally forming six entangled photon pairs. In FIG. 1, colors of each entangled photon pair are labeled as the same. Therefore, a system containing six entangled photon pairs is obtained, where each photon pair strictly follows the law of conservation of energy and has a clear wavelength correspondence.

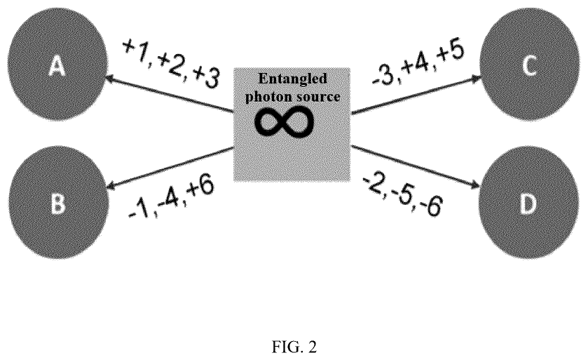

For the principle of quantum communication based on entanglement and wavelength division multiplexing, reference may be made to FIG. 2, which is a schematic diagram of a quantum communication network based on entanglement and wavelength division multiplexing for users. In the entangled network as shown in FIG. 2, each user receives photons from three channels of an entangled photon source. This design ensures that each user can find one photon in an entangled photon pair with any of the another user, for secure communication with other users. However, for a fully connected entangled network with n users, n(n−1) independent communication channels, that is, n(n−1)/2 entangled photon pairs, are needed theoretically, to ensure secure communication between any two users.

However, a significant disadvantage of this solution is that with the increase of the number of users n, the number of required photon pairs increases rapidly. This rapid growth poses a challenge to actual deployment and maintenance of a large-scale entangled network, especially in the context of limited resources and high technical complexity.

On the other hand, related technicians proposed a quantum communication network based on entanglement and wavelength division multiplexing, and successfully demonstrated the quantum communication between four users. Theoretically, the fully connected entangled quantum key distribution of n users can be realized through the wavelength division multiplexing of boardband entangled photons, but it needs to occupy n(n−1) dense wavelength division multiplexing (DWDM) ITU channels (referring to FIG. 2) and generate n(n−1)/2 entangled photon pairs with different frequencies by using an entangled photon source device (referring to FIG. 1). However, this solution is difficult to realize when n is larger.

A beam splitter can be used to expand the number of users n, but its communication quantum key rate is greatly reduced, especially in city areas, where the secure key rate may be lower than 1000 bits per second. In addition, the previous fully connected entangled network usually adopts a star structure by default, and the entangled photon source is placed at a central node of the star structure. However, the network structure of quantum key distribution users in real life is far more complicated than this.

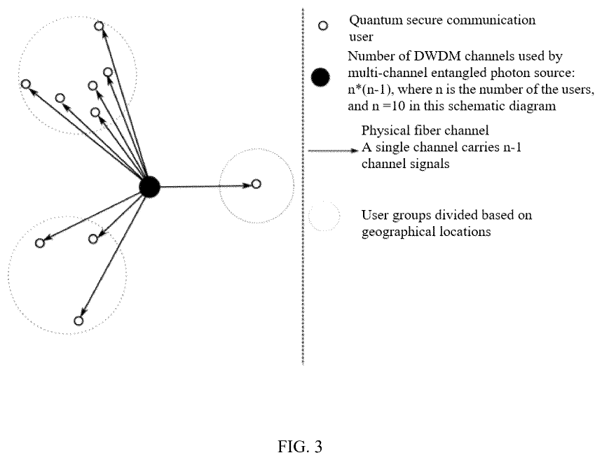

As shown in FIG. 3, FIG. 3 is a schematic diagram of quantum key distribution of a single entangled photon source in the prior art. FIG. 3 shows a schematic diagram of quantum key distribution when there are 10 users in the original quantum key distribution network with a single entangled photon source. In cities, because secure communication users often gather in areas, in order to maximize the average secure key rate of key distribution, the entangled photon source is usually placed at the center of all users to avoid a sharp drop of related secure key rates due to the users being too far away from the center. In FIG. 3, a total of 10*9=90 channels are needed, so 45 entangled photon pairs are needed theoretically, which is usually beyond the capability of a single entangled source.

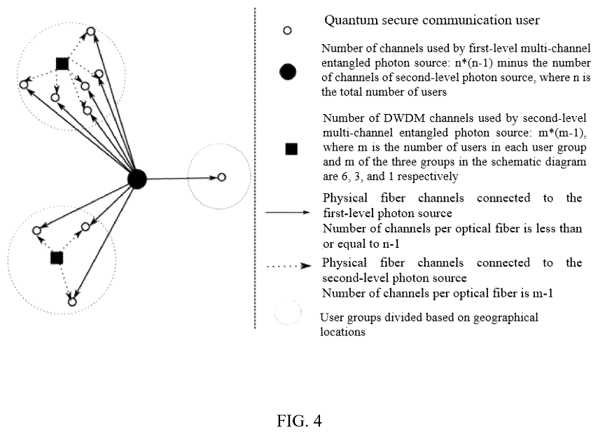

FIG. 4 shows a schematic diagram of a multi-entangled photon source-based quantum key distribution network. As shown in FIG. 4, the network is divided into three user groups, one of which has only a single user and does not need a second-level multi-channel entangled photon source; and the other two user groups include 6 users and 3 users respectively, with each equipped with a second-level multi-channel entangled photon source. For the user group with 6 users, the number of entangled photon channels needed by the second-level multi-channel entangled photon source is 6*5=30, that is, 15 entangled photon pairs are needed. For the user group with 3 users, the number of entangled photon channels needed by the second-level multi-channel entangled photon source is 3*2=6, that is, 3 entangled photon pairs are needed. The central entangled photon source needs to provide 54 additional entangled photon channels (that is, 9*10−30−6=54), which means 27 entangled photon pairs.

Based on this, the embodiments of this disclosure provide a multi-entangled photon source-based multi-level user quantum key distribution network and distribution method, which improves the security, expansibility, efficiency, and optical fiber resource utilization rate of a quantum secure communication network.

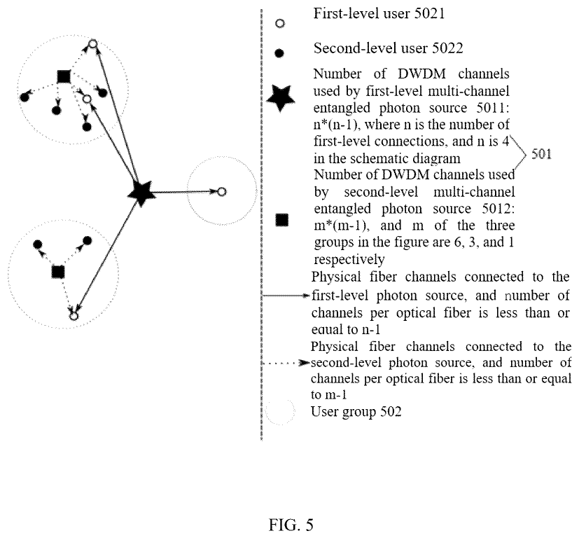

FIG. 5 is a structural schematic diagram of a multi-entangled photon source-based multi-level user quantum key distribution network system provided by an embodiment of this disclosure. As shown in FIG. 5, the multi-entangled photon source-based multi-level user quantum key distribution network system 500 may include:
a multi-level entangled photon source structure 501 for generating entangled photon pairs, including a first-level multi-channel entangled photon source 5011 and at least one second-level multi-channel entangled photon source 5012; and
a plurality of user groups 502 for receiving the entangled photon pairs, where users in each user group 502 are divided into a first-level user 5021 and a second-level user 5022 through a preset user classification manner. Each user group 502 includes at least one first-level user 5021.

Quantum key distribution is performed between the first-level users 5021 through the first-level multi-channel entangled photon source 5011, so as to realize fully connected and secure communication between the first-level users 5021.

In each user group 502, quantum key distribution is performed between the second-level users 5022 and the first-level users 5021 in the group through the second-level multi-channel entangled photon source 5012, so as to realize fully connected and secure communication in each corresponding user group 502.

As the core of the whole network, the first-level multi-channel entangled photon source 5011 is responsible for generating entangled photon pairs, and these photons are distributed to different communication channels. The first-level multi-channel entangled photon source 5011 may have high brightness and multi-channel output capability, and can support fully connected and secure communication between a plurality of first-level users 5021.

The second-level multi-channel entangled photon source 5012 is located inside each user group 502, and the second-level multi-channel entangled photon source 5012 is responsible for providing entangled photon pairs for the second-level users 5022 and the first-level users 5021 in the group, so as to realize fully connected and secure communication within the group. The second-level entangled photon source 5012 can be flexibly configured according to a scale and demand of the user group 502, effectively reducing a bandwidth pressure of the first-level entangled photon source 5011.

In some embodiments, the user groups 502 may be divided based on geographical locations. Through the division of the user groups, the entangled photon pairs generated by the entangled photon sources can be used more effectively, thus improving the communication efficiency and security of the system. Users in each user group 502 are divided into a first-level user 5021 and a second-level user 5022 based on a preset user classification manner. The first-level user usually has a higher communication priority or a greater communication need, while the second-level user may be a user with a relatively low priority or who only needs communication under certain circumstances. The second-level user 5022 mainly communicates with other users in the group to which it belongs, and can also perform indirect communication with the first-level user 5021 in other groups through the first-level users 5021 in its group.

Specifically, the preset user classification manner may be determined according to multiple factors, so as to ensure the efficiency, security, and flexibility of the system. For example, the following division manners may be included:

Based on security requirements: the classification is performed according to the user's requirements on communication security. For example, users with high security requirements (such as government agencies and financial institutions) can be classified as first-level users, while users with lower security requirements (such as ordinary enterprises and individual users) can be classified as second-level users.

Based on communication frequency: the classification is performed according to a communication frequency between users. Users who perform communication frequently can be classified as first-level users, while users with low communication frequency can be classified as second-level users. This classification manner is helpful to optimize network resource allocation and ensure that users of high-frequency communication can obtain better service quality.

Based on user rights: the classification is performed according to the user's rights in the network. Users with high rights (such as network administrators, heads of key sectors, etc.) can be classified as first-level users, while users with low rights can be classified as second-level users. This classification manner is helpful to realize security management and access control of the system.

In practical application, the preset user classification manner can be dynamically adjusted according to specific application scenarios, network scales, user needs, and other factors. Meanwhile, in order to maintain the flexibility and expandability of the system, the classification manner may also need to be continuously optimized and improved with the development of the system.

When performing quantum key distribution, quantum key distribution is performed between the first-level users 5021 through entangled photon pairs generated by the first-level multi-channel entangled photon source 5011. Each first-level user 5021 receives photons from a plurality of channels of the first-level entangled photon source 5011, and finds one photon in an entangled photon pair with any of the other first-level users 5021.

In each user group 502, the second-level users 5022 and the first-level user 5021 in the group perform quantum key distribution through entangled photon pairs generated by the second-level entangled photon source 5012. In this way, each user can find one photon in an entangled photon pair with any of the another user, for secure communication with other users. Therefore, the fully connected and secure communication within the user group 502 is realized, and the communication efficiency and security of the system are improved. Moreover, the bandwidth pressure of a single photon source is further alleviated through the deployment of the second-level entangled photon source 5012.

In the embodiments of this disclosure, the number of users and the communication rate of the quantum secure communication network are expanded by introducing the multi-level entangled photon sources, enabling a network supporting a larger scale of users to be possible. The setting of user groups and classification enables the network to be more flexible, so as to meet the complex and changeable user needs in the real world. The second-level entangled photon source 5012 may be arranged in a telecommunication optical communication band that is not commonly used, which further alleviates the problem of bandwidth limitation of a single photon source and improves the utilization rate of optical fiber resources.

To sum up, the multi-entangled photon source-based multi-level user quantum key distribution network system 500 realizes efficient and secure quantum communication through the multi-level entangled photon source structure, user group division, and user classification manner, and efficient quantum key distribution mechanisms.

In some embodiments, the first-level multi-channel entangled photon source and the second-level multi-channel entangled photon source both perform entangled photon pair distribution through a wavelength division multiplexing (WDM) technology.

Specifically, the first-level multi-channel entangled photon source generates a plurality of entangled photon pairs, two photons in each photon pair are endowed with different wavelength labels, and these entangled photon pairs with specific wavelengths are then combined into a same optical fiber through a wavelength division multiplexer for transmission. Likewise, the second-level multi-channel entangled photon source also follows a similar principle, generating and distributing entangled photon pairs with different wavelength labels. At a receiving terminal, these mixed entangled photon pairs with different wavelengths may be accurately separated by the wavelength division demultiplexer, and sent to different detection channels for subsequent quantum information processing or measurement.

The distribution method of entangled photon pairs based on the wavelength division multiplexing technology not only improves the integration and flexibility of a quantum communication system, but also provides strong technical support for constructing a large-scale and multi-node quantum network. In addition, the wavelength division multiplexing technology also enables the expansion of entangled photon sources to be easier. The number of entangled photon pairs can be easily increased by adding more wavelength channels, thus meeting more complex and higher demanding quantum communication tasks. Moreover, because photons with different wavelengths do not interfere with each other in the transmission process, this distribution method also has good stability and anti-interference ability, which provides a strong guarantee for the reliability and security of quantum communication.

In some embodiments, the first-level multi-channel entangled photon source is arranged at a network center or a central position of the user groups, so as to provide an efficient quantum key distribution service for the first-level users.

It can be understood that by arranging the first-level multi-channel entangled photon source in the center, it can be ensured that all first-level users can receive entangled photon pairs of the photon source in a short transmission distance, thus maximizing the average quantum key rate of key distribution. Specifically, the first-level multi-channel entangled photon source can simultaneously distribute a plurality of entangled photon pairs with different wavelengths to all first-level users through the wavelength division multiplexing technology. Because the photon source is located in the center, the transmission distance between each of the users and the photon source is relatively short, the problems of transmission loss and quantum key rate decline can be effectively alleviated. In addition, this centralized layout also helps to simplify the network structure and reduce network complexity and maintenance costs.

In some embodiments, the second-level multi-channel entangled photon source is arranged inside a corresponding user group, so as to provide quantum key distribution services in the corresponding user group.

Similarly, the second-level entangled photon source is arranged inside the group, which can effectively shorten the distance between entangled photon pairs in the transmission process, thus reducing the transmission loss and improving the communication quantum key rate. This design not only improves the flexibility and reliability of the network, but also enables users in a same group to use the entangled photon pairs for secure communication more efficiently, thus meeting the needs of communication between different users in the group. In addition, because the second-level entangled photon sources deployed in the group are relatively independent, the scale of the user network can be further expanded and the communication property of the network can be improved on the premise of without increasing a burden on the central photon source.

In some embodiments, when deploying the second-level multi-channel entangled photon source, a wavelength band that is not commonly used in telecommunication optical communication and has a slightly higher loss per transmission distance is adopted for arrangement.

It may be understood that when the second-level multi-channel entangled photon source is deployed in a same group, and because the relative transmission distance is relatively short, a wavelength band that is not commonly used in telecommunication optical communication and has a slightly higher loss per transmission distance is adopted for arrangement. This not only further alleviates the problem of bandwidth limitation of a single photon source, but also enables these high-brightness entangled photons to have the potential to co-transmit with existing classical communication photons in a same optical fiber during transmission in infrequently used bands, thus improving the utilization rate of optical fiber resources.

In some embodiments, it is also possible to adopt a hybrid solution using a first-level multi-channel entangled photon source and trusted nodes of a regional user group, and a specific implementation of this solution may include:

In a network architecture, the first-level entangled photon source is still retained as a core part, which is responsible for generating and distributing entangled photon pairs, so as to maintain the basic communication requirements of the network. However, in order to face challenges brought by large-scale user access and complex network structure, this solution introduces the trusted nodes in the regional user group. These trusted nodes are set in or around each user group, serve as relays to enable secure communication between first-level and second-level users who are not directly linked. This is achieved through two quantum key distribution processes: QKD between the trusted node and the first-level user via the first-level entangled photon source, and QKD between the trusted node and the second-level user via the second-level entangled photon source. The participation of these nodes enables the network to cover more users while maintaining high communication efficiency.

It may be understood that although this hybrid solution sacrifices the inherent security of a pure quantum entangled network to some extent because some trusted nodes may become potential attack points, such a sacrifice is acceptable compared with the significant increase in the number of users and the enhancement of network expansibility it brings. Especially in practical application scenarios, users have higher requirements for communication efficiency and network coverage. Therefore, by comprehensively considering the balance between security and expansibility, this hybrid solution of a central entangled photon source and trusted nodes of the regional user group provides a feasible path for the future development of quantum secure communication networks.

In the embodiments of this disclosure, bandwidth requirements can be effectively dispersed by introducing a plurality of entangled photon sources, enabling a quantum entanglement-based quantum secure communication network supporting more than 10 users to be possible. When arranging the second-level photon source, problems of transmission loss and quantum key rate decline caused by an excessively long distance between users in a same user group and a central entangled photon source can be effectively alleviated. The potential of infrequently used bands is used to deploy the second-level entangled photon source in the same group, and because the relative transmission distance is relatively short, a wavelength band that is not commonly used in telecommunication optical communication and has a slightly higher loss per transmission distance may be selected for arrangement. This not only further alleviates the problem of bandwidth limitation of a single photon source, but also enables these high-brightness entangled photons to have the potential to co-transmit with existing classical communication photons (which are in frequently used bands) in a same optical fiber during transmission in infrequently used bands, thus improving the utilization rate of optical fiber resources. Under a multi-user hierarchical framework, the pressure of the central photon source has been further reduced, which provides the possibility for building an entanglement-based secure communication network with more users and a wider range.

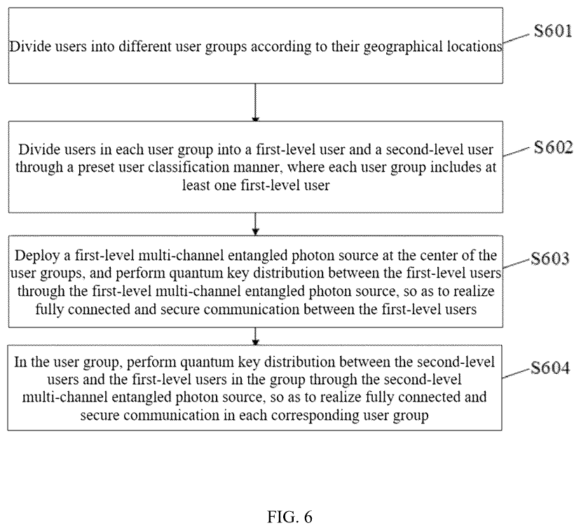

Based on the same inventive concept, an embodiment of this disclosure further provides a multi-entangled photon source-based multi-level user quantum key distribution method, which is applied to the above-mentioned multi-entangled photon source-based multi-level user quantum key distribution network system. FIG. 6 is a schematic flowchart of a multi-entangled photon source-based multi-level user quantum key distribution method provided by an embodiment of this disclosure. As shown in FIG. 6, the method may include:
S601: dividing users into different user groups according to their geographical locations;
S602: dividing users in each user group into a first-level user and a second-level user through a preset user classification manner, where each user group includes at least one first-level user;
S603: deploying a first-level multi-channel entangled photon source at the center of the user groups, and performing quantum key distribution between the first-level users through the first-level multi-channel entangled photon source, so as to realize fully connected and secure communication between the first-level users; and
S604: in the user group, performing quantum key distribution between the second-level users and the first-level users in the group through the second-level multi-channel entangled photon source, so as to realize fully connected and secure communication in each corresponding user group.

In some possible implementations, the first-level multi-channel entangled photon source and the second-level multi-channel entangled photon source both perform entangled photon pair distribution through a wavelength division multiplexing technology.

In some possible implementations, the first-level multi-channel entangled photon source is arranged at a network center or a central position of the user groups, so as to provide an efficient quantum key distribution service for the first-level users.

In some possible implementations, the second-level multi-channel entangled photon source is arranged inside a corresponding user group, so as to provide a quantum key distribution service in the corresponding user group.

In some possible implementations, when deploying the second-level multi-channel entangled photon source, a wavelength band that is not commonly used in telecommunication optical communication and has a slightly higher loss per transmission distance is adopted for arrangement.

In some possible implementations, the user groups are divided based on geographical locations.

The implementations of the present specification are described in a progressive manner. The same or similar parts of the implementations can be referenced mutually. The focus of each implementation is placed on a difference from other implementations.

The above embodiments are merely used for illustrating rather than limiting the technical solutions of this disclosure. Although this disclosure is illustrated in detail with reference to the foregoing embodiments, those of ordinary skill in the art should understand that they can still make modifications to the technical solutions recorded in the foregoing embodiments or make equivalent replacements on some or all of the technical features thereof, and these modifications or replacements do not make the essence of the corresponding technical solutions depart from the scope of the technical solutions of this disclosure.

What is claimed is:

1. A multi-entangled photon source-based multi-level user quantum key distribution network system, comprising:
a multi-level entangled photon source structure for generating entangled photon pairs, comprising a first-level multi-channel entangled photon source and at least one second-level multi-channel entangled photon source; and
a plurality of user groups for receiving the entangled photon pairs, wherein users in each user group are divided into a first-level user and a second-level user through a preset user classification manner; wherein each user group comprises at least one first-level user;
quantum key distribution is performed between the first-level users through the first-level multi-channel entangled photon source, so as to realize fully connected and secure communication between the first-level users; and
in each user group, quantum key distribution is performed between the second-level users and the first-level users in the group through the second-level multi-channel entangled photon source, so as to realize fully connected and secure communication in each corresponding user group.

2. The multi-entangled photon source-based multi-level user quantum key distribution network system according to claim 1, wherein the first-level multi-channel entangled photon source and the second-level multi-channel entangled photon source both perform entangled photon pair distribution through a wavelength division multiplexing technology.

3. The multi-entangled photon source-based multi-level user quantum key distribution network system according to claim 2, wherein the first-level multi-channel entangled photon source is arranged at a network center or a central position of the user groups, so as to provide an efficient quantum key distribution service for the first-level users.

4. The multi-entangled photon source-based multi-level user quantum key distribution network system according to claim 3, wherein the second-level multi-channel entangled photon source is arranged inside a corresponding user group, so as to provide a quantum key distribution service in the corresponding user group.

5. The multi-entangled photon source-based multi-level user quantum key distribution network system according to claim 4, wherein the user groups are divided based on geographical locations.

6. A multi-entangled photon source-based multi-level user quantum key distribution method, applied to a multi-entangled photon source-based multi-level user quantum key distribution network system according to claim 1, comprising:
dividing users into different user groups according to their geographical locations;
dividing users in each user group into a first-level user and a second-level user through a preset user classification manner, wherein each user group comprises at least one first-level user;
deploying a first-level multi-channel entangled photon source at the center of the user groups, and performing quantum key distribution between the first-level users through the first-level multi-channel entangled photon source, so as to realize fully connected and secure communication between the first-level users; and
in the user group, performing quantum key distribution between the second-level users and the first-level users in the group through the second-level multi-channel entangled photon source, so as to realize fully connected and secure communication in each corresponding user group.
